(19) United States
(12) Patent Application Publication
(10) Pub. No.: US 2014/0057681 A1
(43) Pub. Date: Feb. 27, 2014

(54) Adaptive Noise Mitigation for Touch-Screen Displays

(71) Applicants: Chris J. Grivas, Crystal Lake, IL (US); Itisha C. Deokar, Buffalo Grove, IL (US); Michael F. Olley, Lake Zurich, IL (US)

(72) Inventors: Chris J. Grivas, Crystal Lake, IL (US); Itisha C. Deokar, Buffalo Grove, IL (US); Michael F. Olley, Lake Zurich, IL (US)

(73) Assignee: Motorola Mobility LLC, Libertyville, IL (US)

(21) Appl. No.: 13/594,043

(22) Filed: Aug. 24, 2012

(51) Int. Cl. G06F 3/044

(52) U.S. Cl. CPC G06F 3/044
USPC 455/566; 345/174

(57) ABSTRACT

Touch-screen controllers, particularly those in mobile telephones, are prone to erratic behavior when the mobile telephone is plugged into devices, such as AC power adapters, that create electrical noise. To more intelligently mitigate noise in these and other electronic devices that include capacitive touch-screen displays, the present inventors devised, among other things, a touch-screen controller that measures noise level in the touch-screen display and increases its drive voltage only when necessary to exceed the measured noise level, thereby reducing the chance of noise signals being misinterpreted as touch events while also reducing power consumption over prior techniques. Moreover, for electronic devices that include radio receivers, intelligently increasing the touch-screen voltages based on measured noise, avoids the sensitivity-reduction (desense) issues that providing constant higher operating voltage creates.

### TECHNICAL FIELD

Various embodiments disclosed herein concern touch-screen or touch-panel displays, particularly controllers for such displays.

### BACKGROUND

In recent years, touch-screen displays—that is, electronic displays that sense the touch of a finger or stylus—have become relatively common in many types of electronic devices. The devices range from retail payment terminals to automatic teller machines to tablet computers to mobile telephones. One key reason for their prevalence is their intuitive ease of use.

In general, a touch-screen display works by sensing a touch on a glass pane and then communicating the location of the touch to a processor inside the host electronic device. Although the processor interprets the touch based on the information displayed at the touch location, the success of the interpretation depends ultimately on a component, called a touch-screen controller, which determines not only whether a touch event has occurred, but also its precise location.

One problem with conventional touch-screen controllers, particularly those in mobile telephones, is that they are prone to erratic behavior when the mobile telephone is plugged into devices, such as AC power adapters. The power adapters generate electrical noise that sometimes mimics or obscures actual touch events, thus making it difficult for the controllers to determine correctly if and where a touch has actually occurred.

Conventionally, this noise problem as been addressed by raising the drive and threshold voltages in the touch-screen display to fixed higher values, thereby reducing the likelihood that lower voltage noise variations will interfere with proper operation. This solution, analogous to constantly yelling over the noise in a crowded restaurant to be heard, is highly effective. However, it also suffers from two significant disadvantages.

First, it increases power consumption by the touch-screen display and thus reduces the battery life of the mobile telephone or other device using it. Second, operating the touch-screen display at a higher voltage also causes the display to generate its own noise that can interfere with other circuitry, for example, WiFi, cellular, GPS, and Bluetooth radio receivers in a host device, effectively reducing their sensitivity to incoming signals.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example electronic system or device 100 corresponding to one or more embodiments.

FIG. 2A is a schematic diagram of a variable voltage regulator circuit for use in device 100, corresponding to one or more embodiments.

FIG. 2B is a schematic diagram of another variable voltage regulator circuit for use in device 100, corresponding to one or more embodiments.

FIG. 2C is a schematic diagram of another variable voltage regulator circuit for use in device 100, corresponding to one or more embodiments.

FIG. 2D is a schematic diagram of another variable voltage regulator circuit for use in device 100, corresponding to one or more embodiments.

FIG. 3 is a flow chart of an example method of operating a touch-screen controller in system or device 100, and therefore corresponds to one or more embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

This document, which incorporates the drawings and the appended claims, describes one or more specific embodiments of one or more inventions. These embodiments, offered not to limit but only to exemplify and teach the invention, are shown and described in sufficient detail to enable those skilled in the art to implement or practice the invention(s). Thus, where appropriate to avoid obscuring the invention(s), the description may omit certain information known to those of skill in the art.

### Overview

In general, the present inventors devised, among other things, one or more example systems, methods, software, and related components that provide more effective handling of noise in touch-screen controllers. One example system includes a touch-screen controller that measures noise level in capacitive touch-screen circuitry and iteratively increases and decreases the drive voltage as necessary to exceed the measured noise level and achieve desired noise margins relative to the measured noise, thereby reducing the chance of noise signals being misinterpreted as touch events while also reducing power consumption. Moreover, for embodiments that include radio receivers, intelligently adapting the touch-screen voltages based on measured noise, avoids the sensitivity-reduction (desense) issues that providing constant higher operating voltage creates.

### Example System Embodiment(s)

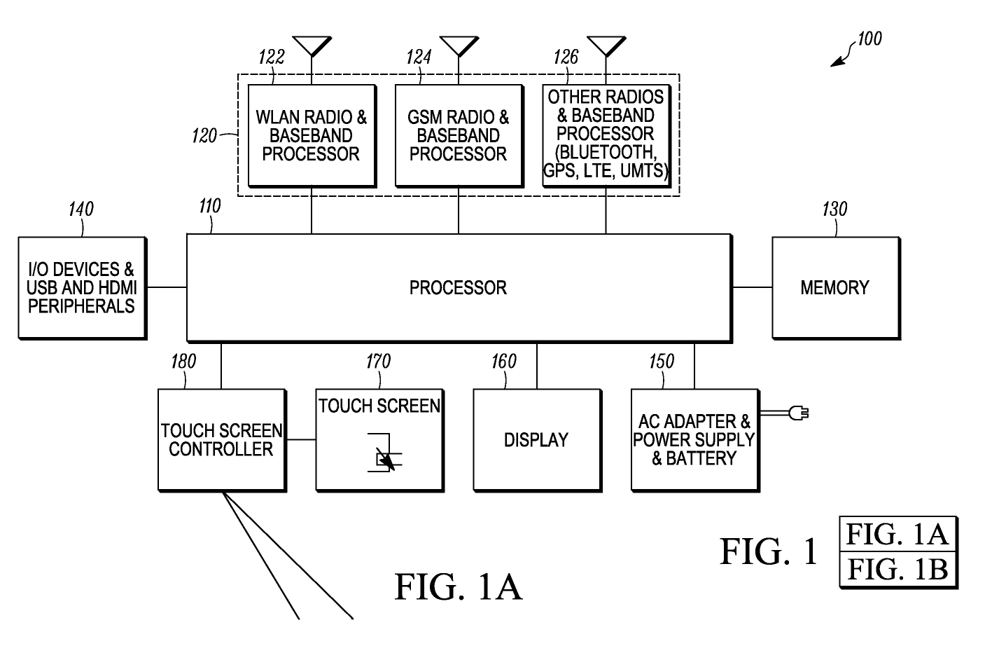

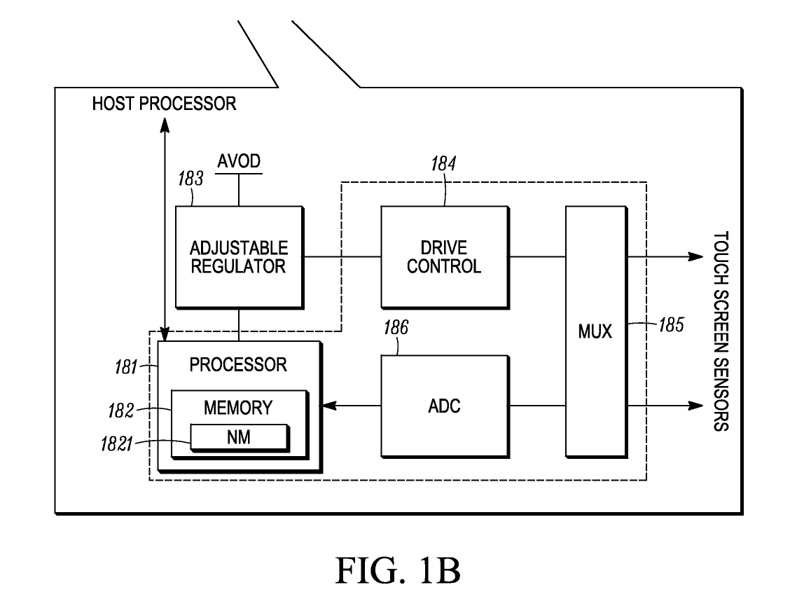

FIG. 1 shows an example electronic device 100 which the form of a mobile communications device, such as smartphone or tablet computer. Other embodiments take the form of personal digital assistants, global positioning systems, navigation systems, media players, point-of-sale terminals, remote controls, and handheld games, indeed any device having a touch-screen display susceptible to ambient electrical noise.

Electronic device 100 includes a processor module 110 electrically coupled to a radio bank 120, a memory module 130, input/output devices 140, a power module 150, display 160, a capacitive touch screen 170, and a touch screen controller 180.

Radio bank 120 includes one or more wireless transceivers and corresponding baseband processors. The example embodiment includes a WLAN (wireless local area network) radio and baseband processor module 122, a GSM radio and baseband processor module 124, and other radio module 126. Other radio module includes additional radio modules, such as Bluetooth piconet, WiFi, (Wireless Fidelity), GPS (Global Positioning System), LTE (Long Term Evolution), and UMTS (Universal Mobile Telecommunications System) radio receivers and/or transceiver modules with corresponding processing circuitry.

Memory module 130 stores an operating system, one or more application programs, and associated data. In the example embodiment, memory module 130 takes the form of one or more electronic, magnetic, or optical data-storage devices.

Input-Output devices 140 includes various keyboards, pointing devices, joy sticks and ports or sockets for connection to peripheral devices, such as HDMI (High Definition Multimedia Interface) and USB (Universal Serial Bus) compliant devices.

Power module 150 includes components and circuitry for providing power to system 100. In the example embodiment, module 150 includes a power supply, one or more batteries, battery-charging circuitry, and an AC adapter; module and plug.

Display 160 takes any conventional form of display technology. For example, some embodiments provide a liquid crystal display, others may include light emitting diodes (LED) or AMOLED or super-AMOLED displays.

Capacitive touch screen 170 cooperates with display 160 and touch screen controller 180 to provide a single or multi-touch input capability for system 100.

More specifically, touch screen controller 180 includes a processor module 181, a memory 182, an adjustable voltage regulator 183, a drive control circuit 184, a multiplexer 185, and an analog-to-digital converter (ADC) 186.

Processor module 181, for example a digital signal processor or microcontroller, operates according to machine readable instructions and data stored within memory 182, which is shown as on-board memory. However, in some embodiments, memory 182 is wholly or partly contained in one or more separate components.

Memory 182 includes a noise mitigation (NM) module 1821, which includes instructions for generally causing processor module 182 to continually or based on events, such as an AC adapter, USB or HDMI plug-in event, measure noise floor level exhibited by touch screen circuitry 170 and to adjust the drive and threshold voltages for the touch screen circuitry to a predetermined level above the measured noise floor, for example 5, 10, 15, 20, 25, 30, or 25%, thereby adaptively mitigating impact of the noise on touch screen performance while reducing impact of the mitigation on battery life and radio sensitivities. In some embodiments, the predetermined amount is a function of other operational or environmental parameters, such as whether an AC adapter or USB connection is present. See below for further details.

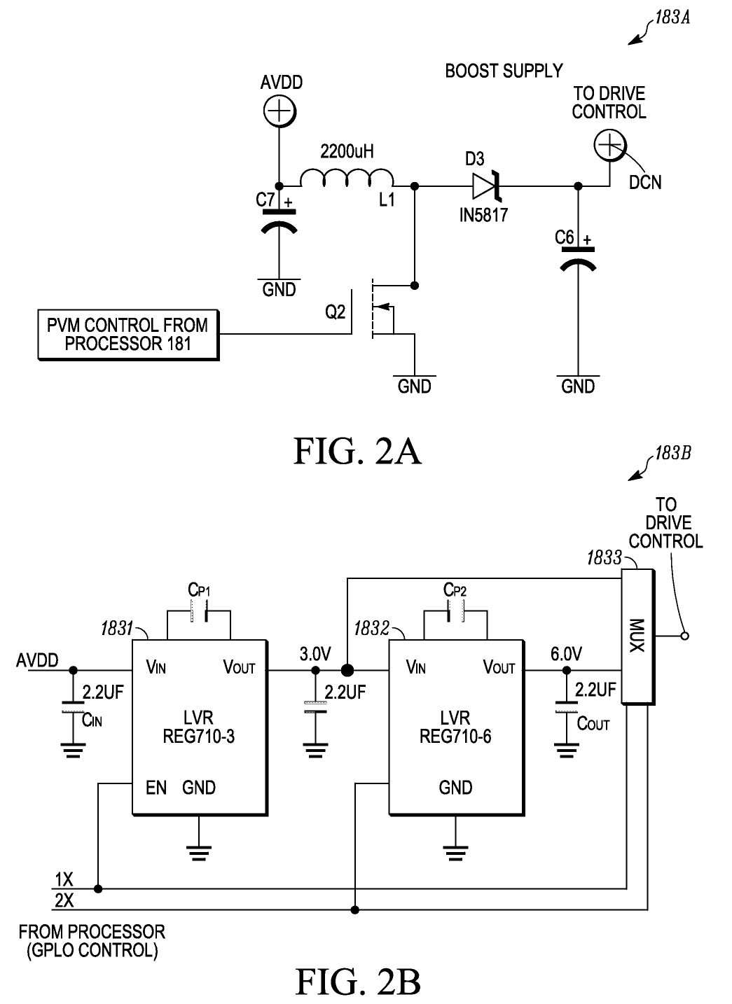

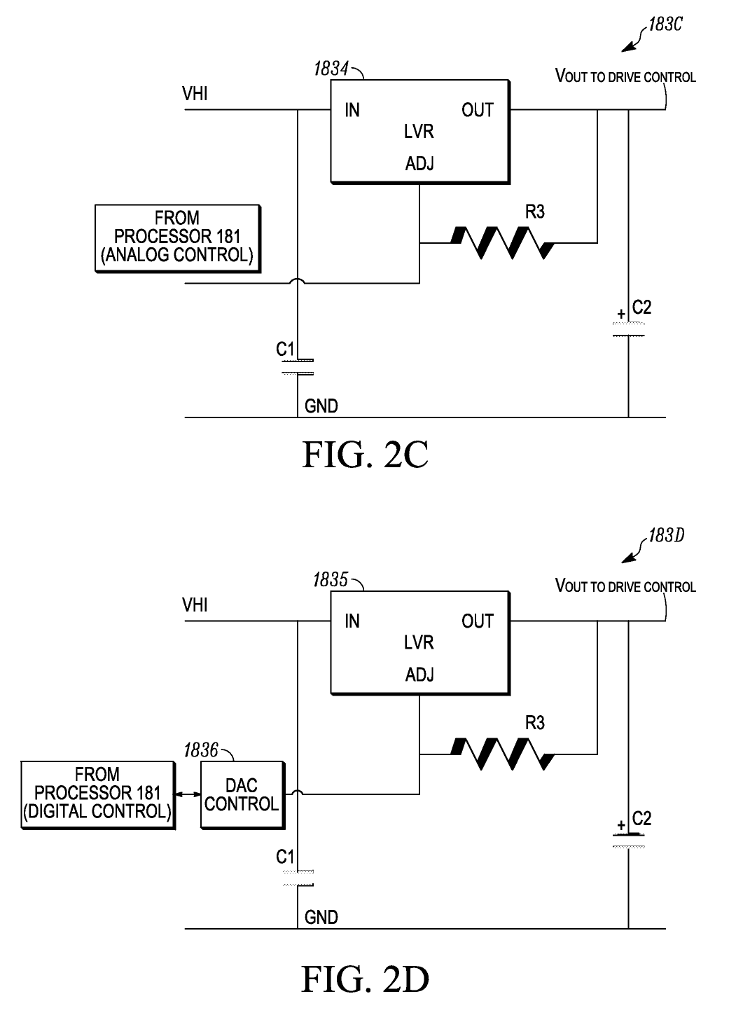

Adjustable voltage regulator 183, which takes an analog or digital form, is responsive to control signals from processor module 181 per direction of noise mitigation module 1821, to provide a regulated voltage signal to drive control circuit 184. FIGS. 2A, 2B, 2C and 2D illustrate example adjustable (or variable) voltage regulator circuits 183A, 183B, 183C, and 183D, which may be used in place of adjustable voltage regulator 183.

Adjustable voltage regulator circuit 183A, in FIG. 2A, which takes the form of a pulse-width modulated (PWM) boost supply circuit, includes a capacitor C7, an inductor L1, field-effect transistor Q2, a diode D3, a capacitor C6, and voltage supply nodes AVDD and GND, and a drive control node DCN. Capacitor C7 is coupled between supply node AVDD and GND. Inductor L1 is coupled between supply node AVDD and an upper controlled node of transistor Q2, which has it other controlled node (lower controlled node) coupled to GND node. Transistor Q2 has its control node coupled to an output pin of processor 181 to receive a PWM signal from processor 181, which switches transistor Q2 on an off for specific time periods to achieve desired drive control voltage at node DCN, which is coupled to drive control 184. Diode D3, a zener diode, is coupled between on the upper control node of transistor Q2 and node DCN, and capacitor C6 capacitively couples node DCN to node GND.

FIG. 2B shows that adjustable voltage regulator circuit 183B takes the form of a multi-stage charge pump circuit, including, among other things, linear voltage regulators (LVRs) 1831 and 1832, and a multiplexer 1833. LVRs 1831 and 1832 each include an input node Vin, an output node Vout, an enable node EN, and a ground or lower supply node GND. Input node Vin of LVR 1831 is coupled to upper supply node AVDD and provides a 3 volt output, which feeds the input node of LVR 1832, which provides a 6 volt output. The LVR outputs are coupled to the inputs of multiplexer 1833, which is controlled by processor 181 to provide the 3- or 6-volt drive voltage into drive control 184. Circuit 183B can be expanded as desired with additional LVRs to provide for greater voltage resolution. (Some embodiments may simply use a voltage divider network in combination with a multiplexer, allowing selection of voltages at various nodes in the network to feed drive control 184.)

FIGS. 2C and 2D shows two additional adjustable voltage regulator circuits, specifically regulator circuits 183C and 183D being supplied with a higher supply voltage (VHI) VHI is a generic nomenclature for a voltage supply of higher voltage. Regulator circuit 183C includes LVR 1834 which is controlled via an analog control signal from processor module 181, whereas regulator circuit 183D includes LVR 1835 controlled via a digital-to-analog converter (DAC) 1836. DAC 1836, which may provide any 2-, 3-, 4-, 5-, 6-bit or greater resolution, is controlled via digital lines from processor module 181. The outputs regulator circuits 183C and 183D are coupled to drive control module or circuit 184 (FIG. 1). Regulators 183C and 183D utilize a higher supply voltage in order to decrease the output voltage.

Drive control circuit 184 receives the voltage from voltage regulator 183 (regardless of its particular form or implementation) and controls the transmission (TX) line drive supply for touch-screen display 170 via multiplexer 185. Analog-to-digital converter 186 converts voltage signals from the touch screen display 170 to a digital signal for use by processor 181, for noise-mitigation processing as well as for conventional touch-screen processing for providing touch data to processor 110.

### Example Method(s) of Operation

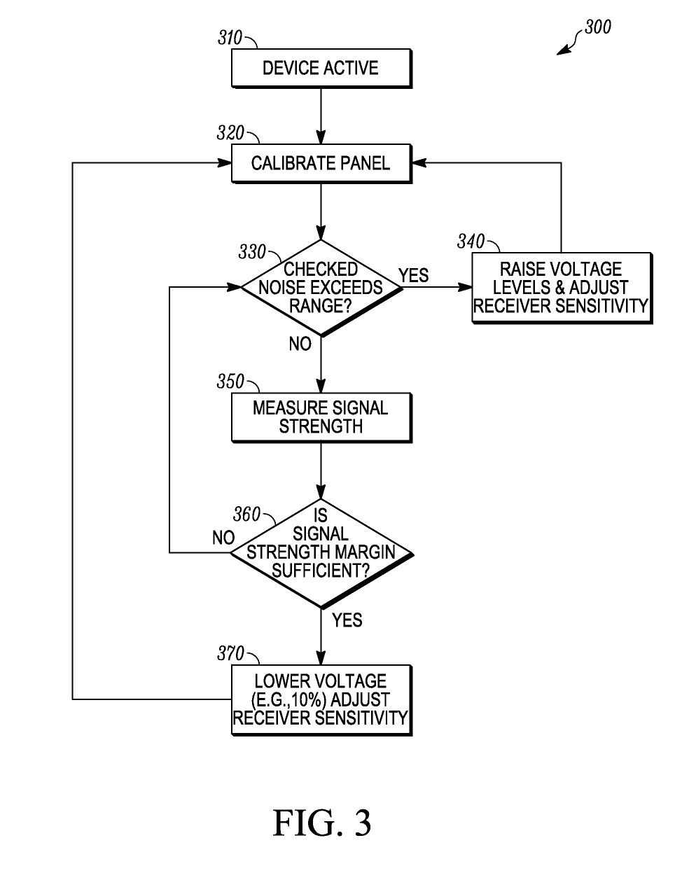

More particularly, FIG. 3 shows a flow chart 300 of one or more example methods of operating touch screen controller 180 within the context of electronic device 100. Flow chart 300 includes blocks 310-370, which are arranged and described in a serial execution sequence in the example embodiment. However, other embodiments are not similarly limited. Moreover, still other embodiments implement the blocks as two or more interconnected hardware modules with related control and data signals communicated between and through the modules. Thus, the example process flow applies to software, hardware, and firmware implementations.

At block 310, the example method begins with activation of electronic device 100. In particularly, this would entail activating system 100 in such as way that touch screen display is activated. Execution continues at block 320.

Block 320 entails calibrating the touch-screen display. In the illustrative embodiment, this calibration entails taking numerous measurements of the electronic device 100 to establish a baseline or expected value of one or more parameters, including the background capacitance on each channel. Other methods for calibration would be acceptable, all with the purpose of properly preparing the system to perform precise measurements of both signal (touches) and noise. Execution continues at block 330.

Block 330 entails determining whether noise level on the touch screen panel circuitry is outside an acceptable range. In the illustrative embodiment, this entails first measuring the noise level by taking a measurement of touch screen panel sensor outputs in the presence of no excitation from the transmitters. Noise can also be measured by examining the normal measurements for high frequency variation from measurement to measurement and across the sets of measurements. The measured noise level is then compared to an acceptable predetermined range which sets a minimum level for signal-to-noise ratio (SNR) performance depending on the system requirements. In some embodiments, the SNR is a fixed level or a level based on past signal data to maintain a desired level of performance (such as sensing no false touches upon the display surface). If the controller determines that the noise level is outside the acceptable range, the execution of the process branches to block 340 and if it is acceptable, execution branches to block 350.

Block 340 entails raising voltage levels in the touch-screen display and adjusting the receiver sensitivity appropriately to match. In the illustrative embodiment, this entails processor 181 issuing some form of command, either a digital communication signal or analog control voltage to the variable adjustable regulator 183 to increase its drive voltage by a predetermined amount, for example 0.5 Volts. It also entails attenuating the receiver input by a corresponding amount. In some implementations, this attenuation (more generally an adaptation or adjustment) is achieved in the analog domain; however, other embodiments make it in the digital domain or in both the analog and digital domains. In some embodiments, the incremental adjustment level is a function of whether or not, the system has detected a plug-in condition, such as when an AC adapter, HDMI, or USB connector has been plugged into the electronic device. In these instances, a more aggressive mitigation protocol, 10, 20, 30, 40, . . . , 100% greater than what would be employed in non-plug-in states may be warranted. Also, in some embodiments, the mitigation protocol is a function of the battery level of the system, enabling responsive mitigation with reduced battery drain.

Block 350, which is executed in response to determining that the noise level is acceptable at block 330, entails measuring touch-screen signal strength. In the illustrative embodiment, the signal strength is measured by sampling and/or averaging one or more touch-screen sensor readings. Execution continues at block 360.

Block 360 entails determining whether the signal strength margin is excessively high. In the example embodiment, this entails comparing the touch-screen signal strength to a minimum acceptable threshold for proper operation, and determining whether the signal strength is greater than that threshold by at least a given value or percentage, for example 10%. (For the sake of radio receiver sensitivity, the illustrative embodiment is designed to look for opportunities to reduce the signal strength while still allowing for proper operation.) If the determination is that the signal strength is not excessive, execution returns to block 330, and if the determination is that it is excessive, execution continues at block 370.

Block 370 entails lowering voltage levels in the touch-screen display and adjusting the touch-screen processor receiver sensitivity appropriately to match. In the illustrative embodiment, this entails processor 181 issuing some form of command, either a digital communication signal or analog control voltage to the variable adjustable regulator 183 to decrease its drive voltage by a predetermined amount, for example 0.5 Volts. It also entails increasing the receiver input by a corresponding amount. In some embodiments, the incremental adjustment level is a function of whether or not, the system has detected a plug-in condition, such as an AC adapter, HDMI, or USB connector being plugged in. Also, in some embodiments, the downgrade slope is a function of the battery level of the system, with higher battery level resulting in a more gradual decrease and lower battery level resulting in more rapid decrease. Execution returns to block 320.

### CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms, such as second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may comprise one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, some embodiments can be implemented as a computer-readable storage medium (more generally a non-transient storage medium) having computer readable code stored thereon for programming a computer (e.g., comprising a processor) to perform a method as described and claimed herein. Likewise, computer-readable storage medium can comprise a non-transitory machine readable storage device, having stored thereon a computer program that include a plurality of code sections for performing operations, steps or a set of instructions.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

The claimed invention is:

1. An electronic device comprising:
a capacitive touch-screen display;
a touch-screen controller circuit coupled to the display, the controller circuit including:
an adjustable voltage source coupled to the display to provide a drive voltage; and
processor circuitry, responsive to a measure of noise level in the display, for causing the adjustable voltage source to adjust the drive voltage provided to the display.

2. The device of claim 1, wherein the processor circuitry, includes a processor coupled to a memory, with the memory including:
a first set of instructions for determining the measure of noise level; and
a second set of instructions, responsive to the measure of noise level, for causing the adjustable voltage source to increase the drive voltage if the measure of noise level is not acceptable.

3. The device of claim 2, wherein the second set of instructions increases the drive voltage by a predetermined voltage value.

4. The device of claim 3, wherein the predetermined voltage value is a function of whether or not the electronic device is electrically connected to an external device.

5. The device of claim 1, further comprising:
at least one radio transceiver and at least one battery for powering the electronic device; and
wherein the processor circuitry iteratively increases the drive voltage in predetermined increments to mitigate interference with the one radio transceiver and conserve life of the one battery.

6. The device of claim 5, wherein the radio transceiver is a cellular radio transceiver.

7. The device of claim 1, wherein the adjustable voltage source is part of a first integrated circuit device and the processor circuitry is a part of second integrated circuit device.

8. The device of claim 1, wherein the adjustable voltage source and the means for causing the adjustable voltage source are contained within one integrated circuit device.

9. A touch-screen controller circuit for coupling to a capacitive touch-screen display, the controller circuit including:
an adjustable voltage source for providing a drive voltage to the display; and
means, responsive to a measure of noise level in the display, for causing the adjustable voltage source to adjust the drive voltage provided to the display and thereby dynamically adjust signal-to-noise ratio of the touch-screen display.

10. The circuit of claim 9, wherein the means for causing the adjustable voltage source to adjust the drive voltage, includes a processor coupled to a memory, with the memory including:
a first set of instructions for determining the measure of noise level; and
a second set of instructions, responsive to the measure of noise level, for causing the adjustable voltage source to increase the drive voltage if the measure of noise level is not acceptable.

11. The circuit of claim 10, wherein the second set of instructions increases the drive voltage by a predetermined voltage value.

12. The circuit of claim 11, wherein the predetermined voltage value is a function of whether or not a system incorporating the circuit is electrically connected to an external device.

13. The circuit of claim 10, further comprising a third set of instructions, responsive to the measure of noise level, for causing the adjustable voltage source to decrease the drive voltage.

14. A method comprising:
determining a measure of noise level in a capacitive touch-screen display; and
in response to the measure of noise level exceeding a predetermined threshold, increasing drive voltage for the touch-screen display from a first drive voltage to a second drive voltage.

15. The method of claim 14, further comprising:
determining a second measure of noise level in the capacitive touch-screen display after increasing the first drive voltage to the second drive voltage; and
in response to the second measure of noise level exceeding the predetermined value, increasing the second drive voltage to a third drive voltage.

16. The method of claim 14, wherein the first drive voltage and the second drive voltage differ by a predetermined voltage value.

17. The method of claim 16, wherein the predetermined voltage value is a function of whether or not an electronic device, incorporating the touch-screen display, is electrically connected to an external device.

18. The method of claim 14, further comprising decreasing the drive voltage in response to determining that a measure of noise level is acceptable.

19. A non-transient machine-readable medium storing:
a first set of instructions for determining a measure of noise level in a capacitive touch-screen display; and
a second set of instructions, responsive to the measure of noise level exceeding a predetermined threshold, for causing an increase in drive voltage for the touch-screen display from a first drive voltage to a second drive voltage.

20. The medium of claim 19, wherein the first drive voltage and the second drive voltage differ by a predetermined voltage value.
